(19) United States
(12) Patent Application Publication
(10) Pub. No.: US 2007/0142643 A1
(43) Pub. Date: Jun. 21, 2007

(54) Preparation of nanoporous metal foam from high nitrogen transition metal complexes

(76) Inventors: My Hang V. Huynh, Los Alamos, NM (US); Michael A. Hiskey, White Rock, NM (US); Darren L. Naud, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/604,644

(22) Filed: Nov. 27, 2006

Related U.S. Application Data
(63) Continuation-in-part of application No. 10/964,218, filed on Oct. 12, 2004, now Pat. No. 7,141,675.

(51) Int. Cl. C07F 15/00

(52) U.S. Cl. 548/101

(57) ABSTRACT

High surface area monolithic foams of essentially pure metal were prepared. Salts of the corresponding metal were prepared as loose powders, pressed into shapes, ignited under an inert atmosphere, and then heated under an atmosphere containing hydrogen to form nanostructured metal foam monoliths of essentially pure metal having a very high surface area.

### RELATED APPLICATIONS

This application is a continuation-in-part of U.S. patent application Ser. No. 10/964,218 entitled “Preparation of Nanoporous Metal Foam from High Nitrogen Metal Complexes” filed Oct. 12, 2004, now allowed, incorporated by reference herein.

### STATEMENT REGARDING FEDERAL RIGHTS

This invention was made with government support under Contract No. W-7405-ENG-36 awarded by the U.S. Department of Energy. The government has certain rights in the invention.

### BACKGROUND

Metal foam has been produced by methods such as melt processing, powder processing, and deposition techniques. Melt processed foams are formed by using either a blowing agent such as a metal hydride, metal carbide, or metal oxide, or by using a lost-polymer investment casting. Metal foams produced using blowing agents often have an inhomogeneous cell structure and density that is due to the non-uniform distribution of blowing agent in the melt. These foams also tend to have a closed cell structure, which limits their uses to structural applications. Open celled foams are preferred for applications related to, for example, catalysis and heat transfer, because the open cell structure allows for the passage of fluid (gas, liquid) through the foam.

Nanostructured metals monoliths have been prepared using polymer or aerogel templates, electrodeposition, and etching of noble metal alloys. Metal monoliths prepared by these methods are typically in the form of powders and thin films, and almost all of these methods require template removal to access the nanoporous metal.

The production of porous monolithic structures without using a template continues to be a challenge. Additional challenges are related to controlling the cell structure and shape of the porous monolith, which will likely have an impact on applications such as catalysis, electrode design, and sensor applications. Understanding the factors that control pore sizes in porous metal monoliths could be used in the rational design of nanoporous metals. Furthermore, the lack of generality and flexibility of the current methods in the preparation of nanoporous materials with a variety of different metals remains a problem. The ability to prepare a variety of different nanoporous metals would significantly expand the range and utility of porous metals.

### BRIEF SUMMARY OF THE INVENTION

In accordance with the purposes of the present invention, as embodied and broadly described herein, the present invention includes a method for preparing a nanoporous metal foam monolith comprising forming a pressed structure of a high nitrogen metal complex, and igniting the pressed structure under an inert atmosphere to form a product, and thereafter heating the product under an atmosphere comprising hydrogen.

The invention also includes monolithic nanoporous metal foam prepared by forming a pressed structure of a high nitrogen metal complex, igniting the pressed structure under an inert atmosphere to form a product, and heating the product under an atmosphere comprising hydrogen.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1 shows an electron micrograph of an embodiment copper foam of the present invention. The hydrogen treatment step involved using essentially pure hydrogen gas. The chemical structure of 2,4,6-trinitrotoluene (TNT) is shown in the figure. Also shown is a depiction of surface plasmons that are believed to result from interactions of Raman scattered light with the foam. The zone depicted represents a “hotspot” junction between particulate features on metal foam.

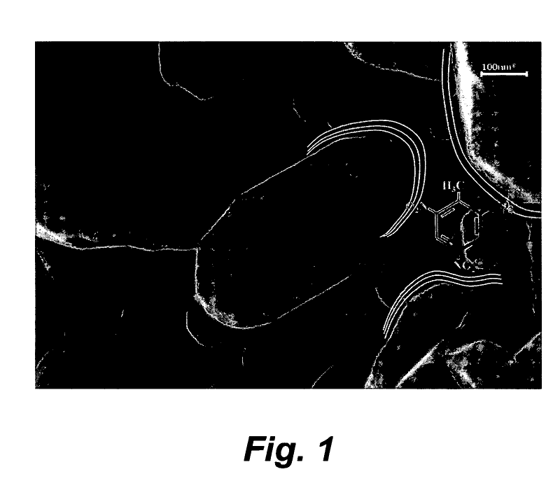

FIG. 2 shows an electron micrograph of an embodiment silver foam of the invention formed from slow decomposition (10° C./min) of 60% AgBTA mixed with 40% dihydrazinobistetrazole (high nitrogen gas generate) under 10% hydrogen gas in argon.

FIG. 3a shows an experimental set-up that was used for preparing an embodiment copper foam of the invention, and FIG. 3b shows an electron micrograph of the copper foam.

### DETAILED DESCRIPTION

Aspects of the invention are concerned with metal foam and with the preparation of monolithic, high surface area metal foam.

Embodiment metal foam monoliths of the present invention are formed from high nitrogen metal complexes. Several were prepared from bi(tetrazolato)amine complexes of metals. The metal complexes were prepared, then pressed into a shape, and then ignited in an inert atmosphere. The products obtained after ignition were heated under an atmosphere containing hydrogen. The result was a substantially pure metal foam monolith having very high surface area.

Embodiment bi(tetrazolato)amine complexes of copper and of silver were ignited in an inert atmosphere and the resulting metal foams were heated under a hydrogen atmosphere. The copper foam prior to heat-treatment was approximately 10 percent relative density with regular, open-pore sizes of approximately 1-2 μm, with considerable close pore structure throughout the foam walls on the order of 20-50 nm. Weight loss results observed from Thermal Gravimetric Analysis (TGA) and elemental analysis indicate that the Cu foam, prior to heat treatment, typically includes about 70 percent Cu metal. According to the energy dispersive spectra (EDS), the product after heat treatment to a temperature of about 500 degrees Celsius under hydrogen atmosphere resulted in an essentially pure, monolithic copper foam with many small, highly faceted crystallites. Face centered cubic crystalline copper was observed, and no amorphous regions were observed.

Thermal decomposition of transition metal complexes (metal carbonyl complexes, for example) typically does not lead to metal foam. Aspects of this invention, by contrast, involve the use of transition metal complexes as precursors for preparing nanostructured metal foam monoliths.

Some embodiment high nitrogen transition metal complexes that are used for making nanostructured metal foam include those of the formula 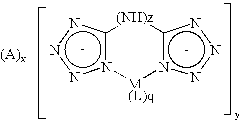
wherein A is ammonium, hydrazinium, guanidinium, aminoguanidinium, diaminoguanidinium, or triaminoguanidinium; wherein x is zero or an integer from 1 to 3, wherein y is an integer from 1 to 3; wherein z is 0 or 1, wherein L is amine; wherein q is 0 or 2; and wherein M is a transition metal.

Metal complexes are typically pressed into a pellet structure and then ignited in a bomb apparatus under a pressure of inert gas (nitrogen, for example). Embodiment foam of the present invention has pore sizes on the order of from about 20 to about 50 nanometers. Pellet ignition may be accomplished using a resistively heated metal wire. Thin wires may be used to minimize cutting the foam as it forms. Prior to ignition, the pellet may be slightly scored to secure the wire loop to the ignition area of the pellet.

A pellet having a size of 6.3 mm in diameter and 6.4 mm in length produced a nanoporous foam monolith that was about 6.1-6.5 mm in diameter and 21 mm in length. Based on the observation that foam monolith appears to form in the flame front of the ignited pellet, the shape of the pellet and the placement of the ignition wire have an effect on the shape of the corresponding foam monolith.

Foam monoliths were also produced from wafers. Typical dimensions for a wafer were on the order of about 12.6 mm in diameter by 3 mm in length. The shape of the resulting foam monoliths formed from wafers depended on whether the wafer was ignited at a central location, or at the edge, of the wafer.

While not intending to be bound by any particular explanation, it appears that the pores of the monolith as the high nitrogen ligand of compound 1, and the other high nitrogen compounds, liberate gases as they decompose.

After ignition, embodiment foam generally includes up to about 50 percent by weight metal. The remainder is mostly carbon and nitrogen. The carbon and nitrogen are removed when the foam is heated at an elevated temperature under an atmosphere that includes hydrogen.

An aspect of this invention relates to the low densities and high surface areas of some embodiment foams. Until now, the lowest achievable densities for metal foam have been in the range of from about 0.04 to about 0.08 g/cm³. These are the densities observed for milliporous metal foams, where their low surface areas are due to the millimeter-scale cell size. By contrast, embodiment metal foams of this invention have even lower densities. In fact, an embodiment metal foam of the invention with a density of 0.0111 g/cm³ was prepared. With respect to the surface area, embodiment foams produced according to this invention are nanoporous and have much higher surface areas than those for known metal foams. A high surface area titania aerogel, for example, has a BET surface area calculated measuring N₂ adsorption isotherms was 100-200 m²/g. By contrast, the BET surface area of an embodiment nanoporous foam of this invention produced by igniting a pressed pellet of an invention transition metal complex over a pressure of about 300 psi was 258 m²/g, much higher than for the titania aerogel.

Foams of this invention that are produced at higher pressures (˜1000 psi) tend to have BET surface areas in the range of from about 12 m²/g to about 17 m²/g.

The generality of the foam preparation was demonstrated by preparing transition metal complexes of the high nitrogen ligand with several different metals and by using the complexes to produce metal foam. Silver and copper complexes of the bi(tetrazolato)amine ligand were prepared, pressed into pellets, and ignited; the result was nanostructured foam of silver and copper, respectively.

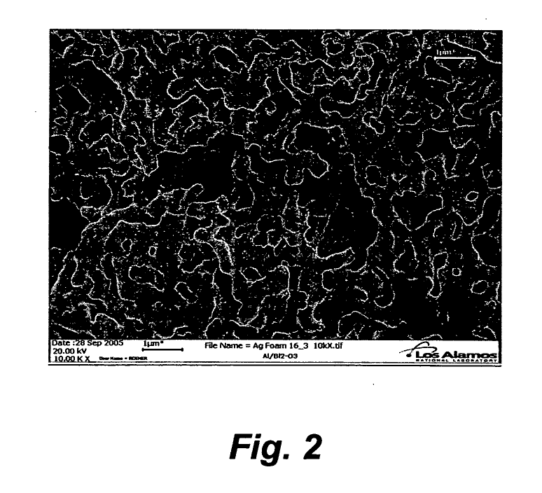

FIG. 2 shows a silver foam formed from slow decomposition (10° C./min) of 60% AgBTA mixed with 40% dihydrazinobistetrazole (high nitrogen gas generate) under 10% hydrogen gas in argon. Energy dispersive spectroscopy indicated that this material is pure silver metal.

The ignition is typically performed on the pellet under an inert atmosphere. Inert gases used included nitrogen and argon, and it is expected that helium and other inert gases and gas mixtures could also be used. Data collected using differential scanning calorimetry (DSC) and thermogravimetric analysis (TGA) indicate that metal nitrides are unlikely products when the ignition is performed under a nitrogen atmosphere. More likely products include carbon nitrides, but signals due to these products disappear at temperatures below about 800 degrees Celsius.

In addition to nanoporous metal foams, metallic nanopowders can also be obtained by applying a high-pressure flow to the burning surface of the pellet.

Optionally, energetic additives (5-amino-tetrazole, for example) can be included into the pellet in order to decrease the density of the resulting foam.

Foam produced after pellet ignition typically includes carbon and nitrogen impurities from the high nitrogen ligand portion of the transition metal complex. These impurities, which are observable and measurable elemental analysis, thermogravimetric analysis, and energy dispersive spectra (EDS), may be removed by heating the foam to a temperature of about 500 degrees Celsius under a hydrogen atmosphere, which can range from 6%-100% hydrogen gas, with the other gas being, argon, nitrogen, helium, or other inert gases.

Metal foam produced according to the present invention has an extremely fine structure and low density. The shape of the die used for pressing the transition metal complex determines the shape of the foam. Complex die shapes result in foams that have substantially the same complex shape as the die.

The following EXAMPLES provide detailed procedures for preparing embodiments of the high nitrogen transition metal complexes of the invention and procedures for transforming these embodiment complexes into foam.

### EXAMPLE 1

Synthesis of copper(II)diammine bis[bi(tetrazolato)-amine] complex (1). Cu^{II}(H₂O)₅ SO₄ (5 g, 20 mmol) and ammonium bi(tetrazolato)amine (3.39 g, 20 mmol) were added to about 50 ml of deionized water. The mixture was stirred and a bright green precipitate was formed of copper(II)bis[bi(tetrazolato)-amine dihydrate. The green solid was filtered and washed with deionized water. Excess ammonium hydroxide was added to an aqueous suspension of the green solid to form copper(II)diammine bis[bi(tetrazolato)-amine] complex (1). Yield: 4.3 g (86%). An equation for the synthesis of 1 is shown below.

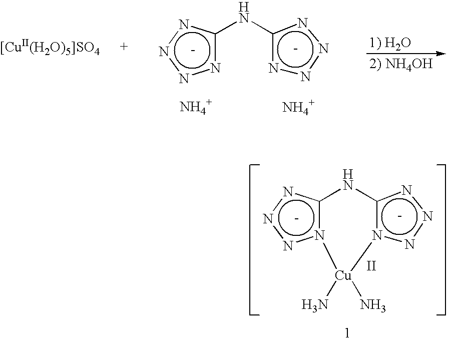

### EXAMPLE 2

Preparation of nanostructured copper foam. Copper(II)diammine bis[bi(tetrazolato)-amine] complex (1) of EXAMPLE 1 was pressed into a thin wafer and combusted in an argon atmosphere, and then heated under a hydrogen atmosphere at a temperature of about 500 degrees Celsius.

### EXAMPLE 3

Synthesis of silver(I) tris[bi(tetrazolato)-amine] complex. Silver nitrate (AgNO₃, 5 g (29.4 mmol)) and ammonium bi(tetrazolate) (5.5 g, 29.4 mmol) were added to about 50 ml of deionized water. The mixture was stirred and a white precipitate was formed. The white solid was filtered, washed with deionized water and methanol, and air-dried in a dark hood with an aluminum foil cover to shield the silver containing compound from light. Elemental Analysis: calculated for Ag₂C₂H₅N₁₀: C, 6.24; H, 1.30; N, 36.4. Found: C, 6.26; H, 0.725; N, 33.76.

### EXAMPLE 4

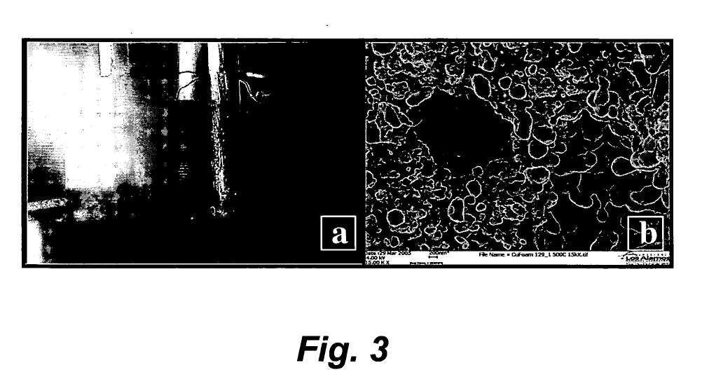

Preparation of nanostructured silver foam. The silver (I) diammonia tris[bi(tetrazolato)-amine] complex of EXAMPLE 3 was prepared as a loose powder. The powder was pressed into a thin wafer and combusted in an argon atmosphere (see FIG. 3a). An electron micrograph of the product is shown in FIG. 2.

### EXAMPLE 5

Preparation of nanostructured silver foam. A mixture of 60-90% of silver (I) diammonia tris[bi(tetrazolato)-amine] complex and dihydrazinobistetrazole (high nitrogen gas generate) were heated at a temperature of about 500 degrees Celsius at a rate of about 10 degrees Celsius per minute under an argon/hydrogen atmosphere. An electron micrograph of the pure silver foam monolith is shown in FIG. 3.

In summary, this invention provides a general and flexible method for preparing nanoporous monolithic metal foams from high nitrogen transition metal complexes.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for preparing a nanoporous metal foam monolith comprising:
forming a pressed structure of a high nitrogen metal complex, igniting the pressed structure under an inert atmosphere to form a product, and thereafter
heating the product under an atmosphere comprising hydrogen.

2. The method of claim 1, wherein the nanoporous metal foam monolith comprises at least one transition metal.

3. The method of claim 1, wherein the nanoporous metal foam monolith comprises at least one metal chosen from silver, copper, iron, nickel, and cobalt.

4. The method of claim 1, wherein the high nitrogen metal complex is of the formula 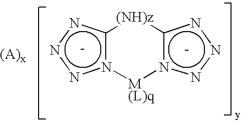
wherein A is selected from ammonium, hydrazinium, guanidinium, aminoguanidinium, diaminoguanidinium, and triaminoguanidinium; wherein x is zero or an integer from 1 to 3, wherein y is an integer from 1 to 3; wherein z is 0 or 1, wherein L is amine; wherein q is 0 or 2; and wherein M is a transition metal.

5. Monolithic nanoporous metal foam prepared by forming a pressed structure of a high nitrogen metal complex, igniting the pressed structure under an inert atmosphere to form a product, and heating the product under an atmosphere comprising hydrogen.

6. The monolithic nanoporous metal foam of claim 5, wherein said foam comprises at least one transition metal.

7. The monolithic nanoporous metal foam of claim 5, wherein said foam comprises at least one metal selected from the group consisting of silver, copper, iron, nickel, and cobalt.

8. The metal foam of claim 5, wherein the high nitrogen transition metal complex is of the formula 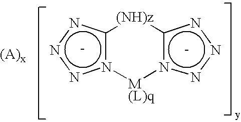
wherein A is selected from ammonium, hydrazinium, guanidinium, aminoguanidinium, diaminoguanidinium, and triaminoguanidinium; wherein x is zero or an integer from 1 to 3, wherein y is an integer from 1 to 3; wherein z is 0 or 1, wherein L is amine; wherein q is 0 or 2; and wherein M is a transition metal.

9. The metal foam of claim 8, wherein M is chosen from titanium, vanadium, chromium, iron, cobalt, nickel, and copper.
